(19) United States
(12) Patent Application Publication
(10) Pub. No.: US 2022/0338500 A1
(43) Pub. Date: Oct. 27, 2022

(54) A DEVICE AND METHOD FOR HEATING A LIQUID CONFECTIONERY PRODUCT

(71) Applicant: Tanis Confectionery B.V., Oosterhout (NL)

(72) Inventor: Leonard Johannes TANIS, Oosterhout (NL)

(21) Appl. No.: 17/764,121

(22) PCT Filed: Sep. 25, 2020
(86) PCT No.: PCT/NL2020/050592

§ 371 Date: Mar. 25, 2022

(30) Foreign Application Priority Data
Sep. 25, 2019 (NL) 2023898

(51) Int. Cl. A23G 3/02; A23G 3/34; F28D 7/16

(52) U.S. Cl. CPC A23G 3/0226; A23G 3/0014; F28D 7/1638; F28D 2021/0042

(57) ABSTRACT

The invention relates to a heat treatment device for heating liquid confectionery product, including: a shell body enclosing an interior space, a plurality of successive spaced apart segmental baffles in a segmented arrangement within the interior space, a bundle of heat exchange pipes within the interior space, the pipes extending through the segmental baffles, and an inlet through which to be heated liquid confectionery product is allowed to enter the interior space, and an outlet through which heated liquid confectionery product is allowed to exit the interior space, wherein the successive segmental baffles are arranged such as to form a flow channel extending between the inlet and the outlet, wherein the segmental baffles have a rectangular shape, and wherein the shell body has a rectangular internal cross-section, such that the flow channel has a substantially rectangular cross-sectional shape along its length. The invention further relates to a method for heating liquid confectionery product.

### FIELD OF THE INVENTION

The invention relates to a device and method for heating liquid confectionery product. The invention further relates to the use of the device for heat treating a liquid confectionery product.

### BACKGROUND TO THE INVENTION

Confectionery such as wine gums, gummy confections, gummy jellies, sweets/candy, etc. can be produced using a liquid confectionery mass which is formed in moulding cavities. After moulding, the confectionery product can cool down and dry, for instance in a conditioning room.

Often confectionery heaters are used for heating up the liquid confectionery product (e.g. containing sugar syrup, colloids). Such a heater can act as a heat exchanger. For this purpose, the heater includes a tubular shell with a plurality of tubes therein. One or more segmental baffles can be added to improve the heat exchange of the liquid confectionery product flowing through the heater. The liquid confectionery can be guided through an interior space formed within the heater. Further, a heat exchange fluid can be guided through the plurality of tubes for heating up the liquid confectionery.

However, the liquid confectionery product within the heater may locally overheat and/or burn within the heater as a result of different heating rates at different locations within the interior space of the heater. This may for instance be a result of slow moving liquid confectionery product at certain locations within the heater. As a result, a degraded heated liquid confectionery product may be obtained. Moreover, this may cause fouling or clogging within the heater, which may require labor-intensive maintenance or even damage to the heater.

There is a need for improving the heat exchange within the heater for heating the liquid confectionery product.

### SUMMARY OF THE INVENTION

It is an object of the invention to provide for a device and a method that obviates at least one of the above mentioned drawbacks.

Additionally or alternatively, it is an object of the invention to provide for a device and a method that provides a low maintenance solution for heating liquid confectionery product in a heat exchanging heat treatment device.

Additionally or alternatively, it is an object of the invention to provide for a device and a method that provides a more uniform velocity of the liquid confectionery product velocity flowing within a heat exchanging heat treatment device.

Thereto, according to an aspect is provided a heat treatment device for heating liquid confectionery product, including: a shell body enclosing an interior space, a plurality of successive spaced apart segmental baffles within the interior space, a bundle of pipes including a plurality of heat exchange pipes, for transferring heat to the liquid confectionery product, within the interior space, the pipes extending through the segmental baffles, and an inlet through which to be heated liquid confectionery product is allowed to enter the interior space, and an outlet through which heated liquid confectionery product is allowed to exit the interior space, wherein the successive segmental baffles are arranged such as to form a flow channel extending between the inlet and the outlet. The segmental baffles have a rectangular shape, and the shell body has a rectangular internal cross-section, such that the flow channel has a substantially rectangular cross-sectional shape along its length.

The segmental baffles may be positioned such that the flow channel meanders, e.g. in a (rounded) zig-zag pattern, through the interior space.

The cross-section of the flow channel along its length may be of significant importance for the governing flow behavior of the liquid confectionery product guided through the heat treatment device. Advantageously, the average fluid velocity along the formed flow channel can be made more constant.

The flow velocity differences within the heat treatment device may be reduced by means of the rectangular cross-sectional shape of the flow channel along its length. By reducing the variation in flow velocity of the liquid confectionery product flowing between the inlet and the outlet along the plurality of segmental baffles, a more uniform heating of the liquid confectionery product can be obtained, such that the risk of local overheating and/or burning of the liquid confectionery product can be reduced. Hence, it can be avoided that the liquid confectionery product is heated in some regions for too long.

By employing a shell body with a rectangular internal cross-section, an interior space can be formed having a rectangular cross-section. Such a shell body with the plurality of rectangular segmental baffles in the longitudinal direction, can result in a flow channel with a rectangular cross-section along substantially its entire length. Due to the rectangular cross section along substantially the entire length of the flow channel, the liquid confectionery product can flow along the formed flow channel with little or no disturbance of the flow, which can result in less flow velocity differences, such that less stagnation occurs of the liquid confectionery product. Hence, the risk of burning of the liquid confectionery product can be reduced.

Advantageously, instead of using a shell body with an ellipsoid or circular internal cross-section, a shell body with a rectangular cross section is employed. In case of a ellipsoid/circular internal cross-section, the cross section of the flow channel between the segmental baffles along its length would be rectangular while the opening window between the free end of the segmental baffle and the interior surface of the shell body would have a half moon shape (with a convex side). This changing of shape of the cross section of the flow channel can result in a non-uniform flow with major speed differences which can result in more stagnation of the flow and hence more risk of burning the liquid confectionery product during heating.

The flow channel with rectangular profile may result in the formation of a more homogeneous flow of the liquid confectionery product. Since the geometric structure of the cross-section of the flow channel is preserved along its length, a more continuous flow can be obtained, resulting in a more uniform heat exchange between the heat exchange pipes and the liquid confectionery product being guided through the interior space of the heat treatment device.

The cross-section of the flow channel along its length may be taken substantially normal to the direction of the flow.

The segmental baffles may be staggered with respect to one another in a longitudinal direction of the shell body. Furthermore, the pipes may extend longitudinally, substantially transversely through the segmental baffles. For this purpose, the segmental baffles can include a plurality of holes through which the pipes can extend. The pipes and the segmental baffles may form a tight fit such that fluid leakage is substantially prevented.

The staggered configuration of the segmental baffles may be obtained by providing segmental baffles which are arranged substantially transverse to the heat exchanging pipes and are relatively staggered with respect to each other. The segmental baffles may be arranged alternatingly, viewed along the longitudinal direction of the bundle of heat exchange pipes. Due to the relatively staggered segmental baffles, the flow of liquid confectionery product may be guided several times around the heat exchanging pipes enhancing the transfer of thermal energy via the heat exchange pipes to the liquid confectionery product flowing in the interior space. The plurality of segmental baffles may divide the interior space in several floors with an opening window alternatingly formed at opposite sides of the shell body. The segmental baffles may also act as support plates. In an example, the segmental baffles may form transverse plates in the longitudinal direction between the inlet and the outlet of the device.

Optionally, the pipes are arranged side-by-side in the interior space formed by the shell body, substantially transversely to the main flow direction of the confectionery product along the formed flow channel along the plurality of segmental baffles. The segmental baffles may be staggered with respect to one another along the bundle of pipes. The segmental baffles may be inwardly extending from the shell body, wherein at a free end an opening window is formed allowing the flow of liquid confectionery product to reach the next segmental baffle. A meandering flow path may be formed along the plurality of segmental baffles.

The cross-sections of the flow channel along its length may be non-circular free of convex or concave regions. The rectangular cross-section may remain rectangular. It will be appreciated that a square shape is also considered as a rectangular shape.

Optionally, the flow channel has a consistent cross-sectional shape along its length.

There may exist a meaningful correspondence between the cross-sections of the flow channel along its length. The shapes of the cross-sections of the flow channel along its length may have explicit properties in common. For instance, a square can remain a square or a rectangular, and a rectangular can remain a rectangular or a square, even where the flow channel bends around a free end of a baffle. The generic geometry of the cross-section of the flow channel may remain the same along its length (i.e. rectangular, square). An advantageous flow can be obtained in the formed flow channel by means of the enforced geometric consistency. By means of the rectangular configuration, it may be easier to obtain a consistent cross-sectional shape of the flow channel along its length. The geometric relation between the cross-sections of the flow channel along its length may be preserved. There can exist a geometrical consistent match between the cross-sections of the flow channel along its length. The cross-sections may have matching features such as to have a high level of geometrical consistency. The cross-sections may be free of deformations, such as a transformation of a straight line to a curved side (e.g. half moon shape). At least the periphery of the cross-section may have a (undeformed) consistent shape.

Inconsistent shapes may adversely affect, deteriorate or even result in dead flows within the flow channel of the heat treatment device. This turns out to be of significant importance in dealing with flow channels having a curved path. A more uniform flow velocity can be obtained while the flow channel can follow a meandering path. The heat treatment device can be obtained for obtaining heated liquid confectionery product without suffering from undesirable stagnation and/or significant differences in flow velocity along the flow channel.

Along the length of the flow channel, the shapes of the cross-sections may have different sizes but geometrically/visually similar to one another, i.e. both rectangular. However, the cross-sections may also have substantially the same size.

Optionally, the cross-sectional profile of the flow channel along its length is continuous. Some variations in flow channel cross-section may be possible, but discontinuous shape variations may be avoided.

Optionally, the shell body and segmental baffles are arranged such that a cross-sectional area of the flow channel remains geometrically similar. In this way, a substantially uniform velocity of the liquid confectionery product through the flow channel can be obtained. A more uniform fluid velocity over the segmental baffles can be obtained.

Optionally, a distance between a free end of a segmental baffle and the interior surface of the shell body is substantially equal to a longitudinal pitch distance between two successive segmental baffles.

The geometric structure of the cross-sections of the flow channel along its length may be consistently preserved, such that a correspondence between the outer line elements of the cross sections exists. A complete matching of the shape of the cross-sections may be obtained when scaled in one or two dimensions. A homogeneous shape mutation may be allowed. The shapes of the cross-sections may be a homogeneous representation of a primary shape.

Optionally, the flow channel has a substantially constant cross-sectional area along its length.

A flow channel with a uniform cross-section along its length can result in a more steady uniform flow, which can be particularly advantageous for avoiding deterioration (e.g. burning) of the liquid confectionery product as a result of non-uniform heating.

It will be appreciated that slight variations in the channel cross-section may be possible, for instance, at turning locations of the flow channel, for instance at or near the window formed between the free end of the segmental baffles and the interior surface of the shell body.

The cross-sections of the flow channel may have a substantially constant equivalent hydraulic diameter along its length. Optionally, the flow channel has a uniform cross-sectional channel, wherein the characteristic length scale represented by hydraulic diameter remains constant along its length and/or along the flow direction.

Advantageously, uneven velocity profiles, back-flows and eddies generated on the shell body side of the segmentally baffled heat treatment device can be reduced, such that a lower fouling with higher run lengths between periodic cleaning and maintenance of the bundle of pipes can be achieved.

Optionally, the shell body and the segmental baffles have a chamfered and/or rounded rectangular shape. The edges of the rectangular body and/or the segmental baffles may be chamfered and/or filleted, such as rounded. This may facilitate cleaning. A radius of such rounding preferably is 1 cm or less.

Optionally, the pipes of the bundle are regularly spaced within the interior space of the rectangular shell body. Optionally, the bundle of pipes extend parallel to one another substantially in a longitudinal direction of the shell body, the pipes being arranged in several rows and disposed adjacent one another.

Optionally, the bundle of pipes further includes one or more passive pipes not configured for transferring heat to the liquid confectionery product. The passive pipes can be hollow pipes or solid rods. The presence of the passive pipes allows to maintain the effect of the presence of the pipes on the flow profile, while adjusting the heating profile of the device by e.g. selectively not heating areas within the shell body in which a reduced flow speed of the confectionery product is measured, estimated, calculated, predicted, expected, etc. Hence the risk of local overheating and/or burning of the liquid confectionery product can be further reduced.

Optionally, a heat transfer achieved by one or more of the heat exchange pipes is adjustable. For example, a flow rate of heating fluid guided through the adjustable heat exchange pipe can be adjusted, e.g. by providing an adjustable valve at the adjustable heat exchange pipe. Hence, a heating profile of the device can be adjusted by e.g. selectively less heating areas within the shell body in which a reduced flow speed of the confectionery product is measured, estimated, calculated, predicted, forecast, expected, etc. Hence the risk of local overheating and/or burning of the liquid confectionery product can be further reduced.

Optionally, the one or more passive pipes and/or the one or more adjustable heat exchange pipes are positioned adjacent corners of the shell body. The positions adjacent the corners of the shell body can be more prone to reduced flow speed of the liquid confectionery product, and thus can have an increased risk of local overheating and/or burning of the liquid confectionery product.

Optionally, the one or more passive pipes and/or the one or more adjustable heat exchange pipes are positioned adjacent positions of expected reduced flow speed of the liquid confectionery product. The one or more passive pipes and/or the one or more adjustable heat exchange pipes can be positioned adjacent positions of measured, estimated, calculated, and/or predicted reduced flow speed of the liquid confectionery product.

The heating treatment device can include a controller for receiving measurement data relating to flow and/or temperature of the liquid confectionery product, e.g. at multiple locations within the shell body, and for adjusting heat transfer to the liquid confectionery product by the adjustable heat exchange pipes on the basis of the measurements.

Optionally, the bundle of pipes has a rectangular outline fitting within the interior space of the rectangular shell body. The rectangular outline of the bundle of pipes enables a more even distribution of the pipes in the interior space. In this way, it can be avoided that some regions of the interior space are more heated than other regions. The bundle of heat exchange pipes may have a regular and/or uniform distribution in order to further enhance the heat exchange within the interior space. Also, the even distribution of the pipes can provide for les disturbance of the flow of the liquid confectionery product.

Optionally, a bypass slit is arranged between at least one of the segmental baffles and the shell body, the bypass slit being configured to enable a leakage flow stream bypassing the segmental baffle at an opening window formed between a free end of that at least one of the segmental baffles and the shell body. The bypass slit may be positioned at the end of the segmental baffle opposite to the opening window.

Stagnation regions and dead zones can at least partially be prevented by means of the bypass slits. The slits may for example be formed by means of a cutout in the at least one of the segmental baffles. An amount of liquid confectionery product is allowed to bypass the longer path along the segmental baffle to the next level of the arrangement of the segmental baffles. In this way, recirculation zones (or dead zones) at the corners formed between the segmental baffles and the interior surface of the shell body can be reduced or even prevented.

Optionally, the slit has a spacing of less than 10 millimeters, more preferably less than 4 millimeters. In this way, a part of the liquid confectionery product can flow past a segmental baffle at which the slit is arranged. Different types of slits may be used.

Optionally, the heat treatment device further comprises a housing surrounding the shell body, wherein the housing e.g. has a cylindrical tubular outer shape.

A cylindrical housing may cost less to construct and may have a relatively simple structure. It may require less materials and take less time to build.

According to an aspect is provided a heat treatment device for heating liquid confectionery product, including a shell body enclosing an interior space, a plurality of successive spaced segmental baffles within the interior space, a bundle of pipes including a plurality of heat exchange pipes, for transferring heat to the liquid confectionery product, within the interior space, the pipes extending through the segmental baffles, and an inlet through which to be heated liquid confectionery product is allowed to enter the interior space, and an outlet through which heated liquid confectionery product is allowed to exit the interior space, wherein the successive segmental baffles are arranged such as to form a flow channel extending between the inlet and the outlet.

Optionally, a heat transfer to the liquid confectionery product of one or more of the heat exchange pipes is adjustable. Optionally, the bundle of pipes further includes one or more pipes configured or adjustable for not transferring heat to the liquid confectionery product.

Optionally, a heat transfer of the one or more of the heat exchange pipes is adjusted on the basis of flow speed of the confectionery product within the flow channel. Optionally, a heat transfer of the one or more of the heat exchange pipes is adjusted on the basis of local flow speed and/or temperature of the confectionery product within the flow channel. The heating treatment device can include a controller for receiving measurement data relating to flow and/or temperature of the liquid confectionery product, e.g. at multiple locations within the shell body, and for adjusting heat transfer to the liquid confectionery product by the adjustable heat exchange pipes on the basis of the measurements.

Optionally, heat transfer of the one or more of the heat exchange pipes is adjusted on the basis of flow speed and/or temperature of the confectionery product at the location of the respective heat exchange pipe.

According to an aspect is provided a method for heat treating a liquid confectionery product, including the steps of: providing a shell body enclosing an interior space, an inlet through which to be treated liquid confectionery product can be entered in the interior space, and an outlet through which treated liquid confectionery product can exit the interior space; providing a plurality of successive spaced apart segmental baffles within the interior space, wherein the successive segmental baffles are arranged such as to form a flow channel extending between the inlet and the outlet, wherein the flow channel has a substantially rectangular cross-sectional shape along its length; providing a bundle of pipes including a plurality of heat exchange pipes within the interior space, the pipes extending through the segmental baffles; and providing to be treated liquid confectionery product to the inlet, allowing the confectionery product to flow along the flow channel, heating the confectionery product using the heat exchange pipes, and extracting the treated liquid confectionery product at the outlet.

According to an aspect, the invention relates to a method for heat treating a liquid confectionery product. The method includes providing a shell body enclosing an interior space, the shell body having a rectangular cross-section, an inlet through which to be treated liquid confectionery product can be entered in the interior space, and an outlet through which treated liquid confectionery product can exit the interior space. The method includes providing a plurality of successive spaced apart segmental baffles within the interior space, the segmental baffles having a rectangular shape, wherein the successive segmental baffles are arranged such as to form a flow channel extending between the inlet and the outlet, wherein the flow channel has a substantially rectangular cross-sectional shape along its length. The method includes providing a bundle of pipes including a plurality of heat exchange pipes within the interior space, the pipes extending through the segmental baffles. The method includes providing to be treated liquid confectionery product to the inlet, allowing the confectionery product to flow along the flow channel, heating the confectionery product using the heat exchange pipes, and extracting the treated liquid confectionery product at the outlet.

As a result of this, a more uniform flow may be obtained such that zones with significantly lower velocity and/or stagnant zones may be reduced. Advantageously, this also reduces the risk of locally burning the liquid confectionery product at such zones. Moreover, product build up (e.g. hardened confectionery product) between the heat exchange pipes can be reduced or avoided.

Optionally, the methods make use of the heat treatment device as described hereinabove.

According to an aspect, the invention relates to a use of the device according to the invention for heat treating a liquid confectionery product.

According to an aspect, the invention relates to a heat treatment device for heating liquid confectionery product, including: a shell body enclosing an interior space, a plurality of successive spaced apart segmental baffles within the interior space, a bundle of heat exchange pipes within the interior space, the pipes extending through the segmental baffles, and an inlet through which to be heated liquid confectionery product is allowed to enter the interior space, and an outlet through which heated liquid confectionery product is allowed to exit the interior space, wherein the successive segmental baffles are arranged such as to form a flow channel extending between the inlet and the outlet, wherein the segmental baffles are arranged such that a flow channel between the inlet and the outlet is formed, wherein the flow channel between a first segmental baffle and a successive second segmental baffle, has a cross-section which at least fits within an opening window formed between a free end of the second segmental baffle and an interior surface of the shell body. Optionally, the successive second segmental baffle is parallel to the first segmental baffle.

Optionally, a longitudinal pitch distance between two successive segmental baffles is smaller or equal to a distance between a free end of the second segmental baffle and the interior surface of the shell body.

It will be appreciated that any of the aspects, features and options described in view of the devices apply equally to the method. It will also be clear that any one or more of the above aspects, features and options can be combined.

### BRIEF DESCRIPTION OF THE DRAWING

The invention will further be elucidated on the basis of exemplary embodiments which are represented in a drawing. The exemplary embodiments are given by way of non-limitative illustration. It is noted that the figures are only schematic representations of embodiments of the invention that are given by way of non-limiting example.

In the drawing:

FIG. 1 shows a schematic diagram of a cross-sectional side view of a heat treatment device;

FIG. 2 shows a schematic diagram of a perspective view of a segmental baffle arrangement;

FIG. 3 shows a schematic diagram of a perspective view of a part of a heat treatment device;

FIG. 4 shows a schematic diagram of a perspective view of a heat treatment device;

FIG. 5 shows a schematic diagram of a perspective view of a part of a heat treatment device;

FIG. 6 shows a schematic diagram of a cross-sectional side view of a segmental baffle arrangement;

FIG. 7 shows a schematic diagram of a part of a heat treatment device;

FIG. 8 shows a schematic diagram of a cross-sectional side view of a heat treatment device; and

FIG. 9 shows a schematic diagram of a method.

### DETAILED DESCRIPTION

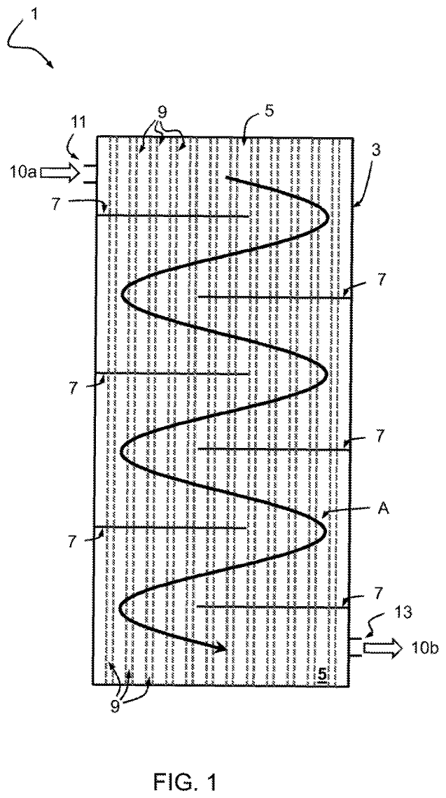

FIG. 1 shows a schematic diagram of a cross-sectional side view of a heat treatment device 1. The heat treatment device 1 is configured to heat liquid confectionery product therein by means of heat exchange. The device 1 comprises a shell body 3 enclosing an interior space 5. The device 1 further comprises a plurality of successive spaced apart segmental baffles 7 within the interior space 5. Here the segmental baffles 7 are alternatingly placed adjacent left and right side walls of the shell body 3. The device 1 comprises a bundle of pipes 9 within the interior space 5. The pipes 9 extend through the segmental baffles 7. In this example, all pipes 9 are heat exchange pipes 9a. The device 1 further comprises an inlet 11 through which to be heated liquid confectionery product 10a is allowed to enter the interior space 5, and an outlet 13 through which heated liquid confectionery product 10b is allowed to exit the interior space 5. The successive segmental baffles 7 are arranged such as to form a flow channel extending between the inlet 11 and the outlet 13. The segmental baffles 7 have a rectangular shape, and the shell body 3 has a rectangular internal cross-section in the longitudinal direction. The flow channel has a substantially rectangular cross-sectional shape along its length.

The flow of the liquid confectionery product follows a (regular) meandering path, here a rounded zig-zag path, through the flow channel with rectangular cross-sections along its length, illustrated by arrow A. The flow channel may have a substantially constant cross section. Major flow differences of the liquid confectionery product can be avoided, such that a more uniform flow can be obtained along the formed flow channel.

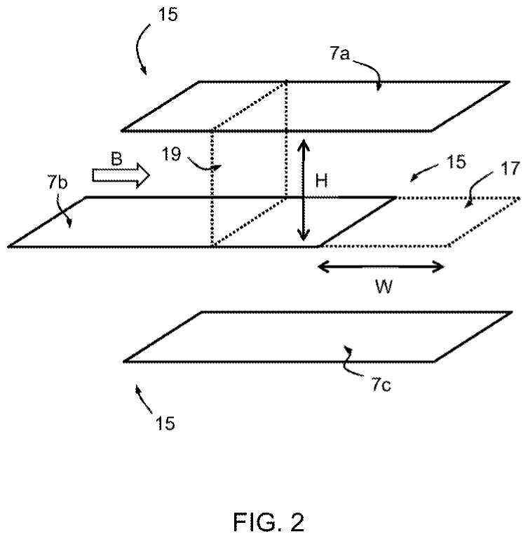

FIG. 2 shows a schematic diagram of a perspective view of a segmental baffle arrangement. For illustrative purposes only three successive segmental baffles 7a, 7b, 7c are shown. However, a different number of segmental baffles 7 may be employed. The baffles are alternatingly arranged on opposite sides of the interior of the shell body 3 (not shown). Between a free end 15 of each baffle 7 and the interior of the shell body 3 an opening window 17 is formed. The flow channel between a first baffle 7a and a successive second baffle 7b, has a cross-section which at least fits within the opening window formed between the free end of the second baffle and an interior surface of the shell body 3. The successive second baffle 7b is parallel to the first baffle.

When the liquid confectionery product flows in direction B in the portion of the fluid channel formed between the first baffle 7a and the second baffle 7b, the cross-sectional shape 19 of the fluid channel along its length can remain rectangular, even when passing through the opening window 17 to the portion of the fluid channel formed between the second baffle 7b and the third baffle 7c.

A longitudinal pitch distance H between two successive baffles may be smaller or substantially equal to a distance W between the free end 15 of the baffle and the interior surface of the shell body 3.

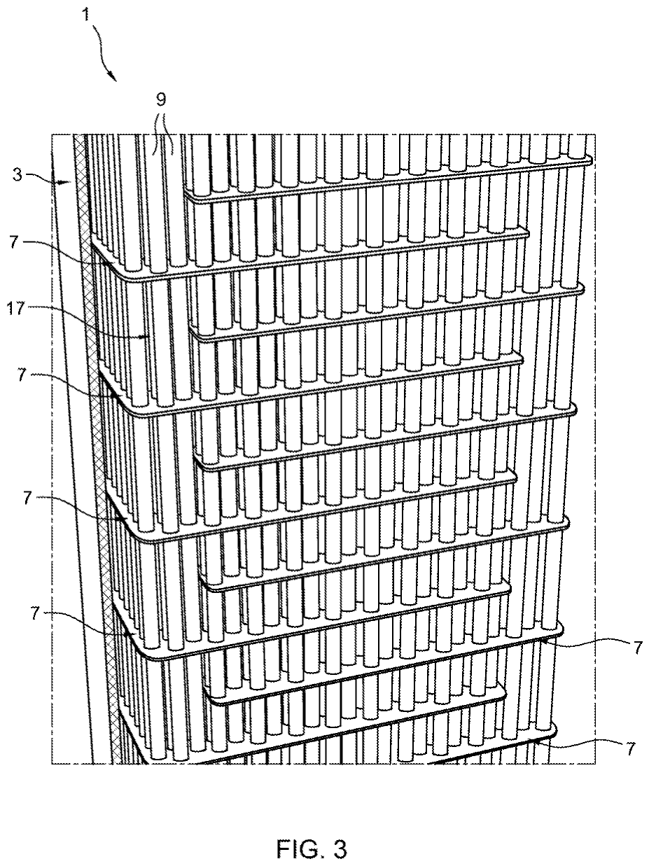

FIG. 3 shows a schematic diagram of a perspective view of a part of a heat treatment device 1. The heat treatment device 1 is configured to heat liquid confectionery product therein by means of heat exchange between the liquid confectionery product and the medium being guided through the heat exchange pipes 9a. The shell body 3 is shown enclosing an interior space 5 of the heat treatment device 1. In FIG. 3 the shell body is shown partly broken away for showing the interior space and the segmental baffles and pipes therein. The device 1 includes a plurality of successive spaced apart segmental baffles 7. The baffles 7 are regularly spaced within the interior space 5. The pipes 9 form a bundle of pipes 9 also regularly spaced with respect to each other. The pipes 9 extend longitudinally within the interior space 5 of the device 1, through the segmented baffles 7. The segmented baffles 7 have a rectangular shape, and the shell body 3 has a rectangular internal cross-section in the longitudinal direction. In this way, the formed flow channel along the plurality of baffles 7 and the interior of the shell body 3 has a substantially rectangular cross-section along its length. A meandering path is followed by the formed flow channel, running along the plurality of segmental baffles 7. In this example, the plurality of baffles 7 have a rectangular shape with chamfered and/or rounded edges. Also the shell body 3 may have chamfered and/or rounded edges for ease of manufacturing and cleaning.

The pipes 9 may be extending through the plurality of baffles being fixedly and tightly connected thereto. The baffles are arranged in a segmented configuration between the inlet and the outlet. The baffles are configured to reverse the direction of the flow of the liquid confectionery product, wherein the baffles leave an opening window 17 (i.e. a flow passage) for the flow alternately on one side and the opposite side of the interior of the shell body. The baffles extend from the interior of the shell body and point inwards.

The pipes 9 are arranged in several rows and disposed in parallel adjacent one another.

In the example of FIG. 3 the bundle of pipes includes a plurality of heat exchange pipes 9a. In use, the heat exchange pipes 9a transfer heat to the liquid confectionery product. Here, the bundle of pipes 9 also includes passive pipes 9b. The passive pipes 9b here are positioned at the corners of the bundle of pipes, adjacent the corners of the shell body 3. The passive pipes 9b do not transfer heat to the liquid confectionery product.

Alternatively, or additionally, heat transfer of one or more of the heat exchange pipes 9a is adjustable. For example a flow of heat exchange medium through the adjustable heat exchange pipe 9a can be adjusted, e.g. by providing an adjustable valve at the adjustable heat exchange pipe 9a. Hence, a heating profile of the device can be adjusted by e.g. selectively less heating areas within the shell body in which a reduced flow speed of the confectionery product is measured, estimated, calculated, predicted, forecast, expected, etc. Hence the risk of local overheating and/or burning of the liquid confectionery product can be further reduced. The heat treatment device 1 can include a controller for receiving measurement data relating to flow and/or temperature of the liquid confectionery product, e.g. at multiple locations within the shell body, and for adjusting heat transfer to the liquid confectionery product by the adjustable heat exchange pipes on the basis of the measurements. The controller can e.g. adjust controllable valves associated with the adjustable heat exchange pipes. Hence, and optimum heating of the liquid confectionery product can be provided as a function of the flow profile through the shell body 3. It will be appreciated that the adjustable heat exchange pipes can also be used in conjunction with a shell body having a non-rectangular internal cross section.

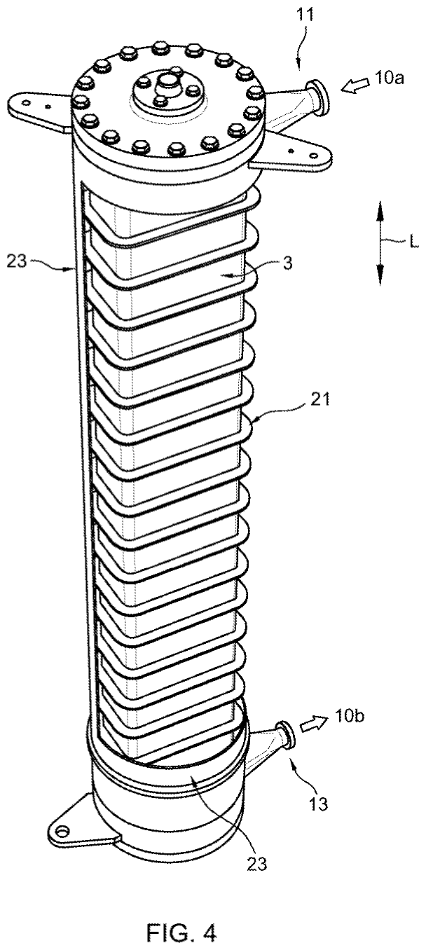

FIG. 4 shows a schematic diagram of a perspective view of a heat treatment device 1. The shell body 3 has a rectangular shape and forms an rectangular internal cross-section in the longitudinal direction L. In this example, ribs 21 are arranged at the shell body 3 for enhancing the structural stability and/or stiffness of the shell body 3. Furthermore, a cut-out representation of a housing 23 is shown. The housing 23 is configured to surround the shell body 3 and has a cylindrical tubular outer shape. The successive segmented baffles 7 are arranged such as to form a flow channel extending between the inlet 11 and the outlet 13, the flow channel having a substantially rectangular cross-section shape along its length. The flow channel may follow a meandering path along the segmental baffles 7 which have a rectangular shape.

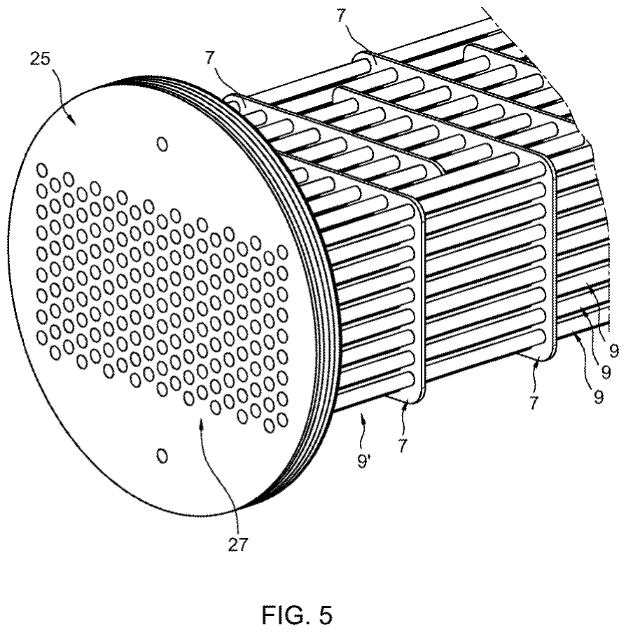

FIG. 5 shows a schematic diagram of a perspective view of a part of a heat treatment device 1. A bundle 9′ of pipes 9 are shown extending through a plurality of rectangular segmental baffles 7 positioned in a single segmental arrangement in order to form a flow channel having a rectangular cross-section along its length. The internal cross section of the shell body 3 (not shown) is also rectangular for this purpose. The plurality of heat exchange pipes 9a are connected with a barrier plate 25 with a plurality of corresponding holes 27. The heat exchange medium can be guided to the plurality of heat exchange pipes 9a through the plurality of holes 27. It will be appreciated that in case the bundle 9′ includes a passive pipe 9b, the passive pipe 9b will not have an associated hole 27 in the barrier plate. Hence, flow of heat exchange medium through the passive pipe can be avoided. It will be appreciated that it is also possible that the passive pipe itself is solid or otherwise prevents heat exchange medium from flowing therethrough.

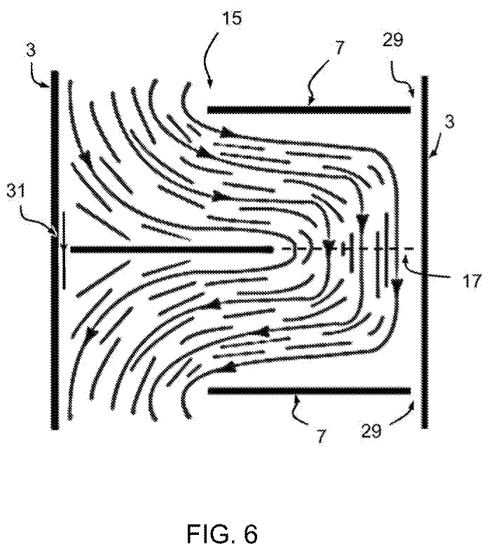

FIG. 6 shows a schematic diagram of a cross-sectional side view of a baffle arrangement. In this example, a bypass slit 29 is arranged between the baffles 7 and the shell body 3. The bypass slit 29 is configured to enable a leakage flow stream 31 bypassing the opening window 17 formed between the free end 15 of the baffle 7 and the shell body 3. In this way, stagnant zones can be avoided in the corners between the baffles and the shell body.

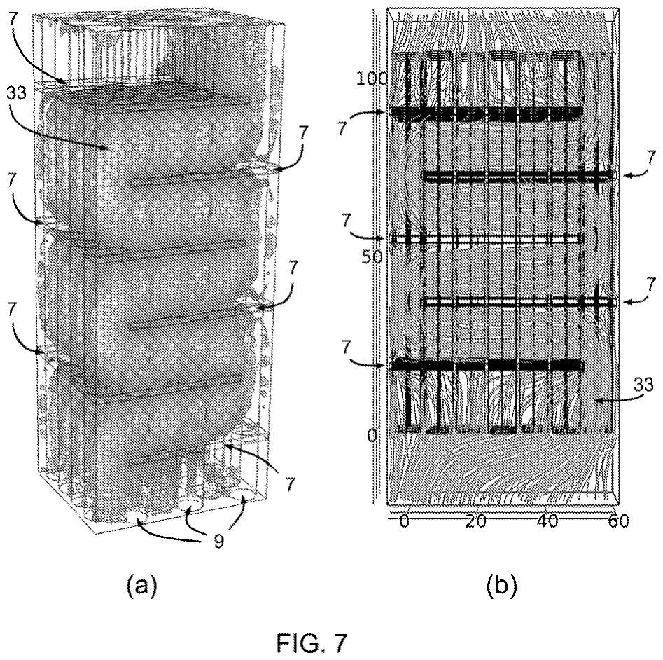

FIG. 7 shows a schematic diagram of a part of a heat treatment device 1 with visualization of the flow 33 of liquid confectionery product being treated therein. In FIG. 7a and FIG. 7b, a perspective view and a side view are shown, respectively. As can be seen in FIG. 7a, a flow channel with a rectangular cross-section along its length is formed. For this purpose, a plurality of rectangular segmental baffles 7 are employed arranged in segmented configuration. A volume flow representation is shown in FIG. 7a. In FIG. 7b streamlines are shown which indicate the direction in which the liquid confectionery product travels through the interior space of the device 1.

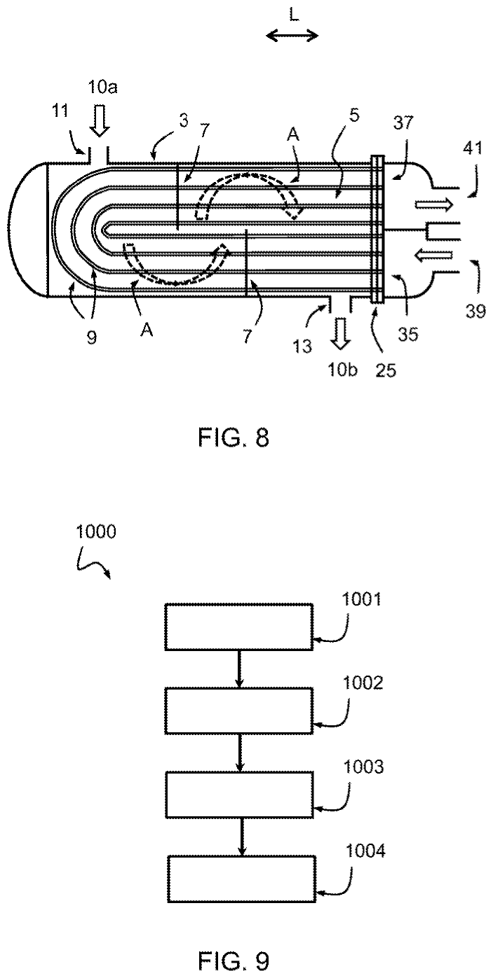

FIG. 8 shows a schematic diagram of a cross-sectional side view of a heat treatment device 1. The heat treatment device 1 is configured to heat liquid confectionery product by means of heat exchange provided by heat exchange medium guided through the plurality of heat exchange pipes 9a. Although straight heat exchange pipes 9a are shown in the previous figures, the pipes 9 may also have a different configuration. For example, the heat exchange pipes may be curved. As shown in the example of FIG. 8, the tubes may be bent in the shape of a U within the interior space 5 enclosed by the shell body 3 of the device 1. In this example, the heat exchange pipes 9a are looped within the interior space 5. The shell body 3 has a rectangular cross-section in the longitudinal direction (not shown). The heat exchange pipes 9a have an inlet end 35 and an outlet end 37. Hot heat transfer medium can be provided to the inlet end 35 of the heat exchange pipes through reservoir 39. Within the interior space 5, heat can be transferred from the heat exchange medium to the liquid confectionery product by means of the heat exchange pipes 9a. The heat exchange medium will subsequently reach reservoir 41 through the outlet ends 37 of the heat exchange pipes. It will be appreciated that the pipes 9 may also have a different orientation or configuration than shown in the example of FIG. 8. It will be appreciated that the passive pipes 9b can also be used in the configuration of FIG. 8.

The device 1 comprises two segmental baffles 7 within the interior space 5. A flow channel is formed running along the baffles, wherein the cross-sectional shape of the flow channel remains rectangular along its length. A flow of the liquid confectionery product can be obtained with a more uniform velocity distribution. It will be appreciated that a larger number of baffles 7 may also be employed.

FIG. 9 shows a schematic diagram of a method 1000 for heat treating a liquid confectionery product. In a first step 1001, a shell body is provided enclosing an interior space, the shell body can have a rectangular cross-section, an inlet through which to be treated liquid confectionery product can be entered in the interior space, and an outlet through which treated liquid confectionery product can exit the interior space. In a second step 1002, a plurality of successive spaced apart segmental baffles are provided within the interior space, the segmental baffles can have a rectangular shape, wherein the successive segmental baffles are arranged such as to form a flow channel extending between the inlet and the outlet, wherein the flow channel has a substantially rectangular cross-sectional shape along its length. In a third step 1003, a bundle of pipes including a plurality of heat exchange pipes is provided within the interior space, the pipes extending through the segmental baffles. In a fourth step 1004, to be treated liquid confectionery product is provided to the inlet, the confectionery product is allowed to flow along the flow channel, the confectionery product is heated using the heat exchange pipes, and the treated liquid confectionery product is extracted at the outlet.

Herein, the invention is described with reference to specific examples of embodiments of the invention. It will, however, be evident that various modifications, variations, alternatives and changes may be made therein, without departing from the essence of the invention. For the purpose of clarity and a concise description features are described herein as part of the same or separate embodiments, however, alternative embodiments having combinations of all or some of the features described in these separate embodiments are also envisaged and understood to fall within the framework of the invention as outlined by the claims. The specifications, figures and examples are, accordingly, to be regarded in an illustrative sense rather than in a restrictive sense. The invention is intended to embrace all alternatives, modifications and variations which fall within the spirit and scope of the appended claims. Further, many of the elements that are described are functional entities that may be implemented as discrete or distributed components or in conjunction with other components, in any suitable combination and location.

In the examples, the heat exchange pipes carry a heat exchange medium or heat exchange fluid for transferring heat to the confectionery product. It will be appreciated that the heat exchange pips can also transfer heat to the confectionery product in different ways. For example, the heat transfer pipes can include electrical heating means.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage.

1. A heat treatment device for heating liquid confectionery product, including:
a shell body enclosing an interior space,
a plurality of successive spaced segmental baffles within the interior space,
a bundle of pipes including a plurality of heat exchange pipes, for transferring heat to the liquid confectionery product, within the interior space, the pipes extending through the segmental baffles, and
an inlet through which to be heated liquid confectionery product is allowed to enter the interior space, and an outlet through which heated liquid confectionery product is allowed to exit the interior space, wherein the successive segmental baffles are arranged such as to form a flow channel extending between the inlet and the outlet,
wherein the segmental baffles have a rectangular shape, and wherein the shell body has a rectangular internal cross-section, such that the flow channel has a substantially rectangular cross-sectional shape along its length.

2. The heat treatment device according to claim 1, wherein the flow channel has a consistent cross-sectional shape along its length.

3. The heat treatment device according to claim 1, wherein the flow channel has a substantially constant cross-sectional area along its length.

4. The heat treatment device according to claim 1, wherein the shell body and the segmental baffles have a chamfered and/or rounded rectangular shape.

5. The heat treatment device according to claim 1, wherein the pipes of the bundle are regularly spaced within the interior space of the rectangular shell body.

6. The heat treatment device according to claim 1, wherein the bundle of pipes further includes one or more passive pipes not configured for transferring heat to the liquid confectionery product.

7. The heat treatment device according to claim 1, wherein a heat transfer of one or more of the heat exchange pipes is adjustable.

8. The heat treatment device according claim 6, wherein the one or more passive pipes and/or the one or more heat exchange pipes are positioned adjacent corners of the shell body.

9. The heat treatment device according claim 6, wherein the one or more passive pipes and/or the one or more heat exchange pipes are positioned adjacent positions of expected reduced flow speed of the liquid confectionery product.

10. The heat treatment device according to claim 1, wherein the bundle of pipes has a rectangular outline fitting within the interior space of the rectangular shell body.

11. The heat treatment device according to claim 1, wherein a bypass slit is arranged between at least one of the segmental baffles and the shell body, the bypass slit being configured to enable a leakage flow stream bypassing an opening window formed between a free end of the at least one of the segmental baffles and the shell body.

12. The heat treatment device according to claim 1, further comprising a housing surrounding the shell body, wherein the housing has a cylindrical tubular outer shape.

13. A heat treatment device for heating liquid confectionery product, including:
a shell body enclosing an interior space,
a plurality of successive spaced segmental baffles within the interior space,
a bundle of pipes including a plurality of heat exchange pipes, for transferring heat to the liquid confectionery product, within the interior space, the pipes extending through the segmental baffles, and
an inlet through which to be heated liquid confectionery product is allowed to enter the interior space, and an outlet through which heated liquid confectionery product is allowed to exit the interior space, wherein the successive segmental baffles are arranged such as to form a flow channel extending between the inlet and the outlet.

14. The heat treatment device according to claim 13, wherein a heat transfer of one or more of the heat exchange pipes is adjustable.

15. The heat treatment device according to claim 13, wherein the bundle of pipes further includes one or more pipes configured or adjustable for not transferring heat to the liquid confectionery product.

16. The heat treatment device according to claim 14, wherein heat transfer of the one or more of the heat exchange pipes is adjusted on the basis of flow speed of the confectionery product within the flow channel.

17. The heat treatment device according to claim 16, wherein heat transfer of the one or more of the heat exchange pipes is adjusted on the basis of flow speed of the confectionery product at the location of the respective heat exchange pipe.

18. A method for heat treating a liquid confectionery product, including the steps of:
providing a shell body enclosing an interior space, an inlet through which to be treated liquid confectionery product can be entered in the interior space, and an outlet through which treated liquid confectionery product can exit the interior space;
providing a plurality of successive spaced apart segmental baffles within the interior space, wherein the successive segmental baffles are arranged such as to form a flow channel extending between the inlet and the outlet, wherein the flow channel has a substantially rectangular cross-sectional shape along its length;
providing a bundle of pipes including a plurality of heat exchange pipes within the interior space, the pipes extending through the segmental baffles; and
providing to be treated liquid confectionery product to the inlet, allowing the confectionery product to flow along the flow channel, heating the confectionery product using the heat exchange pipes, and
extracting the treated liquid confectionery product at the outlet.

19. The method according to claim 18, using a heat treatment device according to claim 14.

20. Use of the device according to claim 1 for heat treating a liquid confectionery product.
